(19) United States
(12) Patent Application Publication
(10) Pub. No.: US 2026/0328421 A1
(43) Pub. Date: Oct. 22, 2026

(54) HEATING, VENTILATING AND AIR CONDITIONING HVAC DEVICE

(71) Applicant: BELIMO HOLDING AG, Hinwil (CH)

(72) Inventors: Stefan JENNI, Wattwil (CH); Silvio GROGG, Wetzikon (CH); Peter SCHMIDLIN, Uster (CH); Peter BÖHLE, Hombrechtikon (CH); Sebastian EBERLE, Kusnacht (CH)

(73) Assignee: BELIMO HOLDING AG, Hinwil (CH)

(21) Appl. No.: 19/117,467

(22) PCT Filed: Oct. 3, 2023
(86) PCT No.: PCT/EP2023/077299

§ 371 Date: Apr. 1, 2025

(30) Foreign Application Priority Data
Oct. 4, 2022 (CH) CH001158/2022

(51) Int. Cl. F24F 11/46

(52) U.S. Cl. CPC F24F 11/46

(57) ABSTRACT

An add-on Heating, Ventilating and Air Conditioning (HVAC) device block includes a housing, an add-on electronic circuit and an add-on interface. The add-on HVAC device block establishes, upon attachment of the add-on interface to an extension interface of a base HVAC device block, a first electrical connection between the add-on electronic circuit and an external electrical interface and a second electrical connection between the add-on electronic circuit and an HVAC functional device of the base HVAC device block. The add-on HVAC device block is operable in a sensor operation mode, for operation with a base HVAC device block including a sensor; and/or an actuator operation mode for operation with a base HVAC device block including an actuator for actuating a drivingly attached actuated part.

### FIELD OF THE INVENTION

The present invention relates to an add-on Heating, Ventilating and Air Conditioning HVAC device block, an HVAC field device comprising a base HVAC device block and an add-on HVAC device block. The present invention further relates to a method of operating an HVAC field device. The present invention even further relates to a computer program product for operating an add-on HVAC device block.

### BACKGROUND OF THE INVENTION

As people spend an estimated 90% of their time indoors, Heating, Ventilating and Air Conditioning HVAC systems have become of great importance to everyday life and have a great impact on people's health and comfort. In the field of Heating, Ventilating and Air Conditioning, HVAC systems typically comprise a fluid transportation system comprising one or more fluid transportation circuit(s), one or more of the fluid transportation circuit(s) being connected to a heat exchanger arranged such as to be able to transfer thermal energy to/extract thermal energy from the environment to be controlled by means of a fluid circulating in said fluid transportation system.

In order to be able to regulate the flow of fluid to/from the heat exchanger and hence the amount of thermal energy transferred, the heat exchanger is connected to the fluid transportation system via one or more regulating devices, such as valves and dampers. The regulating devices are mechanically controlled by HVAC field devices, in particular actuators, including motorized HVAC actuators coupled to the regulating device(s). In the field of HVAC, HVAC actuators typically comprise an electric motor, drivingly coupled (through gears and/or other mechanical coupling), to the actuated part, i.e. the regulating device. HVAC actuators are electrically controlled by HVAC controllers, in particular an electronic circuit of HVAC controller(s). In addition, various HVAC sensors are used to measure environmental variables such as humidity, temperature, CO₂ or dust particle levels. Furthermore, HVAC sensors are used to determine operational parameters of various elements of an HVAC system, such as an actuated position of an actuated part, the operational state of an HVAC actuator, e.g. online/standby/offline, operating temperature, error state, etc.

HVAC systems commonly comprise an HVAC controller configured to generate control signal(s) for operating the HVAC actuator(s) and/or process signals from the HVAC sensors. In typical HVAC applications, the HVAC controller(s) generate the control signals for the HVAC actuators according to various control algorithms (e.g. with regards to differential pressure, room temperature, flow of energy, etc.) to thereby actuate the actuators, such as to open and close an orifice of a valve or damper to regulate the flow of fluid.

Certain control functions of HVAC systems may be performed from a remote server arranged remote from the controlled environment, the remote server comprising a computer program such as a Building Management System BSM to control and monitor a building's mechanical and electrical equipment. Furthermore, certain functions, in particular the commissioning and/or configuration of HVAC systems may be performed by means of portable devices, such as a general purpose mobile computing device (e.g. a smartphone) or a dedicated configuration tool.

In summary, devices of HVAC systems may be categorized into two categories by their location with respect to the controlled environment: remote devices (arranged remote from the controlled environment) and field devices (located within the controlled environment or mechanically connected, e.g. by the fluid transportation system, to the controlled environment). Field devices implement one or more electrical and/or mechanical functions and/or other functions (e.g. hydraulic, optical) and comprise—but not limited to—actuators, sensors, or a combination thereof.

HVAC field device are devices hydraulically and/or mechanically connectable to at least part of fluid transportation circuit(s) with fluid supply/return lines, such as pipes, ducts or ports of valves and/or dampers such as to regulate and/or measure parameters of fluid(s) flowing therethrough, parameters such as flow rate, temperature, humidity, pressure, viscosity and/or chemical composition. Alternatively, or additionally, HVAC field devices are connectable to other HVAC field device(s) such as to control and/or measure parameters thereof, such as valve position, as well as speed, current and voltage of actuator(s), as well as positions of flow regulating devices, such as valves and/or dampers, etc.

HVAC field devices for regulating flow (parameters) of fluid(s) are referred to as HVAC actuators. HVAC actuators typically comprise a motor, such as an electric motor, and a mechanical drive for drivingly connecting the electric motor to an actuated part such as a valve or damper. HVAC actuators typically further comprise an interface for receiving electrical power; control and/or configuration signals.

HVAC field devices for measuring parameters of fluid(s) are referred to as HVAC sensors. Furthermore, the term HVAC field device also encompasses HVAC field devices combining sensor and actuator functions, for both controlling and measuring parameters of fluid(s) or other HVAC field device(s).

With increasing complexity of HVAC systems, there is an ever increasing demand for a wide variety of field devices implementing various electrical and/or mechanical and/or thermal HVAC functions and/or other functions (e.g. hydraulic, optical). Even for the same function, a range of HVAC field devices are required to cover a wide array of use cases each characterized by different parameters. For example, for the mechanical function of actuating a valve or a damper, different variants of a certain type of HVAC actuator Are required to cover a wide range of flow regulation by means of valves of different sizes, requiring different actuation forces (e.g. a torque ranging from 1 Nm up to 160 Nm or even more). Different variants of HVAC actuators are also required to cover different power supplies and also different actuation times. Furthermore, the nature of the controlled environment also leads to varying demands on the HVAC field devices. For example, special variants of HVAC field devices are needed to be suitable for use in harsh environments. In addition, depending on the architecture of the HVAC system, various variants of HVAC field devices are needed to cover the different types of connectivity requirements.

Covering such a wide range of mechanical functions, electrical functions and suitable for such a wide range of environments, results in a very high number of HVAC field devices that need to be manufactured, serviced and maintained. Using known methods of manufacturing, satisfying such demand for a wide range of HVAC field devices is complex and therefore costly for manufacturers. In addition to complex and costly manufacturing, the function of known HVAC field devices is often difficult to expand or alter without having to exchange the entire HVAC field device.

In order to address the need to provide a wide range of HVAC devices in a large number of different configurations without having to manufacture a specific type of HVAC field device for each possible combination of functions and/or parameters, HVAC field devices are assembled from multiple HVAC device blocks, the HVAC device blocks fulfilling various HVAC functions, wherein the HVAC functionality of a base HVAC device block—comprising an HVAC functional device such as a motor or sensor—is extended by HVAC functionality provided by add-on HVAC device blocks. However, known modular HVAC field devices are assembled from base HVAC device blocks and add-on HVAC device blocks specifically designed for being attached to a base HVAC device block comprising either sensor(s) or actuator(s).

Hence, there is an unmet need to provide HVAC device blocks specifically adapted such that both base HVAC blocks and add-on HVAC device blocks can be re-used flexibly, wherein base HVAC blocks and add-on HVAC device blocks can individually or collaboratively provide HVAC functionalities.

### SUMMARY OF THE INVENTION

It is an object of embodiments disclosed herein to provide an add-on HVAC device block, an HVAC field device, a method of operating an HVAC field device and a computer program product for an add-on HVAC device block that overcome one or more of the disadvantages of the prior art. According to the present disclosure, this object is achieved by the features of the independent claims.

In addition, further advantageous embodiments follow from the dependent claims and the description.

In particular, it is an object of embodiments disclosed herein to provide HVAC device blocks specifically adapted such that both base HVAC blocks and add-on HVAC device blocks can be re-used flexibly, wherein base HVAC blocks and add-on HVAC device blocks can individually or collaboratively provide HVAC functionalities.

The above-identified objectives are addressed according to the present disclosure by an add-on HVAC device block comprising a housing, an add-on electronic circuit, and an add-on interface arranged on the housing. The add-on electronic circuit is arranged within the housing, i.e. within an interior space defined by the housing and/or (at least partially) integrated into the housing. The add-on interface is arranged on the housing, i.e. on or (at least partially) protruding from an external surface of the housing.

The add-on HVAC device block is configured for being attached to a base HVAC device block having an extension interface electrically connected to an external electrical interface, wherein the add-on interface of the add-on HVAC device block is arranged and configured such as to be attachable to the extension interface of a base HVAC device block. The base HVAC device block further comprises an HVAC functional device electrically connected to the extension interface.

Advantageously, the add-on interface is arranged on the housing and configured such as to be mechanically attachable and electrically connectable to a base HVAC device block through a (compatible) extension interface thereof.

The add-on HVAC device block is configured such as to establish, upon attachment of the add-on interface to the extension interface of the base HVAC device block a first electrical connection between the add-on electronic circuit and the external electrical interface of the base HVAC device block. Furthermore, the add-on HVAC device block is configured such as to establish, upon attachment of the add-on interface to the extension interface of the base HVAC device block, a second electrical connection between the add-on electronic circuit and an HVAC functional device of the base HVAC device block. The first electrical connection in combination with the second electrical connection enable routing of data communication between the external electrical interface and HVAC functional device of the base HVAC device block through the add-on electronic circuit.

In order to enable a flexible deployment—either as part of a sensor or an actuator—the add-on HVAC device block is configured to be operable in a sensor operation mode and an actuator operation mode. The add-on HVAC device block is operable in the sensor operation mode for operation with a base HVAC device block having an HVAC functional device comprising and/or communicatively connected to a sensor configured to measure a parameter of an HVAC system. The add-on HVAC device block is operable in the actuator operation mode for operation with a base HVAC device block having an HVAC functional device comprising an actuator for actuating a drivingly attached actuated part. Hence, the add-on HVAC device block attached to a base HVAC device block forms an HVAC field device of a sensor type and/or of an actuator type.

According to embodiments of the present disclosure, the actuator of the HVAC functional device comprises an electric motor arranged within the housing to drive an actuated part. On the other hand, the sensor of the HVAC functional device of the base HVAC device block is configured to measure a parameter of the HVAC system, in particular an environmental parameter, such as a temperature, humidity, particulate matter PM and/or CO2 level of an environment controlled by the HVAC system. Alternatively, or additionally, the sensor of the base HVAC device block is provided to measure operational parameters of various components of the HVAC system such as an actuated position of the actuated part and/or the operational state of the HVAC field device and/or other parameters of the HVAC system, such as a flow rate or differential pressure at locations of a liquid through a fluid transportation system. The extension interface of the base HVAC device block is arranged on the housing and provided to accommodate an add-on HVAC device block, in particular by stacking, by connecting to a counterpart add-on interface of the add-on HVAC device block.

According to embodiments disclosed herein, the add-on HVAC device block—and hence the HVAC field device is caused to operate in a sensor operation mode or the actuator operating mode by sending a configuration signal to the add-on HVAC device block, such as by bringing a corresponding NFC transponder in the proximity of the add-on HVAC device block and/or by sending a configuration signal to the add-on HVAC device block via the external electrical interface (of base HVAC device block) and/or by manual actuation of an electromechanical switch arranged on the add-on HVAC device block.

Alternatively, or additionally, according to embodiments disclosed herein, the add-on HVAC device block is configured to activate the sensor operation mode upon attachment to a base HVAC device block having an HVAC functional device comprising and/or communicatively connected to a sensor configured to measure a parameter of an HVAC system and to activate the actuator operation mode upon attachment to a base HVAC device block having an HVAC functional device comprising an actuator for actuating a drivingly attached actuated part. Such embodiments are advantageous as they allow a plug-and-play kind of assembly of an HVAC field device without the need for manually switching operation of the add-on HVAC device block in accordance with the type of base HVAC device block. Such in turn speeds up installation time and mitigates the risks of human error. According to embodiments, automatic activation of the sensor operation mode or the actuator operation mode upon attachment of the add-on HVAC device block to a base HVAC device block is achieved in that the add-on electronic circuit is configured to detect whether the HVAC functional device comprises and/or is communicatively connected to a sensor or whether the HVAC functional device comprises an actuator. In a first variant, the add-on electronic circuit is configured to transmit an inventory enquiry signal to the base HVAC device block, enquiring whether the HVAC functional device comprises and/or is communicatively connected to a sensor or whether the HVAC functional device comprises an actuator. The add-on electronic circuit is further configured to process an inventory response to the inventory enquiry signal from the base HVAC device block, the inventory response comprising data indicative whether the HVAC functional device comprises and/or is communicatively connected to a sensor or whether the HVAC functional device comprises an actuator. Alternatively, or additionally, in a second variant, the add-on HVAC device block is configured to interact with electro-mechanical elements of the base HVAC device block (such as encoding protrusions, switching pins or the like), the electro-mechanical elements identifying the respective base HVAC device block as comprising a sensor or an actuator.

According to embodiments, the add-on HVAC device block is configured such as to enable a bidirectional data flow from the HVAC functional device to the external electrical interface of the base HVAC device block via the add-on electronic circuit.

In order to enable specific commands to be executed by the HVAC field device—assembled by attaching an add-on HVAC device block to a base HVAC device block—the add-on electronic circuit is provided with computer readable instructions comprising a sensor command set and/or an actuator command set. According to embodiments, the sensor command set and/or the actuator command set may be provided to/retrieved by the add-on electronic circuit from a memory device internal or communicatively connected to the add-on electronic circuit. Alternatively, or additionally, the sensor command set and/or the actuator command set are provided to/retrieved by the add-on electronic circuit via a communication interface of the add-on HVAC device block from an external computing device, such as a mobile computing device and/or a remote server.

According to embodiments, the computer readable instructions comprising a sensor command set and/or an actuator command set are provided as a computer software program, a binary (executable), a firmware, an embedded application or as part of program logic of a Field Programmable Gate Array and/or an Application Specific Integrated Circuit ASIC.

According to embodiments, the add-on HVAC device block is configured such as to receive/retrieve the sensor command set and/or the actuator command set in accordance with the sensor operation mode respectively the actuator operation mode, such as on a need to basis. Alternatively, the sensor command set and/or the actuator command set are pre-loaded onto a memory module of the add-on HVAC device block upon manufacture, installment or commissioning.

In the sensor operation mode, the add-on electronic circuit is configurable (or pre-configured upon manufacture, installment or commissioning) to carry out one or more instructions of the sensor command set such as to receive raw sensor signals generated by the sensor of the base HVAC device block using the second electrical connection, process the raw sensor signals into processed sensor signal and transmit processed sensor data (also referred to as interpreted data) signals to the external electrical interface of the base HVAC device block using the first electrical connection. Shifting the processing of raw sensor signals generated by the sensor to the add-on electronic circuit, enables the reduction of the data processing requirements of the base HVAC blocks, reducing their complexity and costs. Furthermore, alternative data processing and communication protocols can be added to extend the functionality of base HVAC device block having a sensor. In particular, processing raw sensor signals comprises converting signals generated by the sensor into signals representative of and/or derived from the parameter measured by the sensor. According to embodiments, values of additional physical properties—not directly measured by the sensor of the base HVAC device block—may be derived by the add-on electronic circuit based on the raw sensor signals. For example, enthalpy may be derived by the add-on electronic circuit based on measurements of temperature and relative humidity by the sensor of the base HVAC device block. As a further example, an amount of thermal energy transfer may be derived by the add-on electronic circuit based measurements of temperature differential and flow rate by the sensor of the base HVAC device block.

According to embodiments disclosed herein, attachment of the add-on HVAC device block enables processing of data signal(s) according to communication protocols not supported by the electronic circuit of the base HVAC device block. For example, while the electronic circuit of the base HVAC device block only supports analog communication protocols, the add-on electronic circuit is configured to further support digital communication protocols (e.g. RS485, KNX, MP-Bus, I2C).

In the actuator operating mode, the add-on electronic circuit is configurable (or pre-configured upon manufacture, installment or commissioning) to carry out one or more instructions of the actuator command set such as to receive actuator data signals from the external electrical interface of the base HVAC device block using the first electrical connection, process actuator data and generate actuator control signals for operating the actuator of the base HVAC device block, and to transmit actuator control signals to the actuator of the base HVAC device block using the first second electrical connection. In particular, processing actuator data signals comprises converting signals from the external electrical interface of the base HVAC device block into actuator control signals for driving the actuator, such as signals to drive an electric motor mechanically connected to an actuated part, such as a valve or damper, for example to bring an actuated part to a specified position, opening a flow regulating member to a specified percentage by actuating an actuated part, etc. The control signals may be digital signals but also analog signals, such as specific currents or voltages to drive an electric motor.

In order to enable on-site and/or remote configuration, according to embodiments, the add-on HVAC device block is configured to receive configuration data via the external electrical interface (of base HVAC device block), while the add-on electronic circuit is configured to process the raw sensor signals and/or the actuator data signals in accordance with the configuration data. Alternatively, or additionally, in order to enable on-site and/or remote configuration, according to embodiments the add-on HVAC device block further comprises a communication interface, such as a wired or wireless communication interface. The add-on HVAC device block is configured to receive configuration data via the communication interface, while the add-on electronic circuit is configured to process the raw sensor signals and/or the actuator data signals in accordance with the configuration data. According to embodiments, the communication interface is a wired communication interface and/or a radio communication device. In particular, the communication interface comprises one or more of:
A wired communication interface (such as an Ethernet, in particular a Power over Ethernet PoE, Single Pair Ethernet SPE, a BUS, in particular an MP Bus, BACnet, KNX or Modbus interface);
A Wide Area Network communication circuit (such as GSM, LTE, 3G, 4G or 5G mobile communications circuit);
A Low Power Wide Area Network (such as Narrowband Internet of Things NB-IoT, Long Range LoRa/LoRaWAN, SigFox, or Long Term Evolution Category M1 LTECatM1);
A local area network communication circuit (such as Wireless LAN);
A short range wireless communication circuit (such as Bluetooth, Bluetooth low energy BLE, Ultra-wideband UWB, Thread and/or Zigbee); and/or
A close-range wireless communication circuit (such as Radio Frequency Identification RFID or a Near Field Communication NFC).

According to embodiments, for establishing the first electrical connection the add-on interface comprises signal connector(s) attachable to corresponding signal connector(s) of the extension interface of a base HVAC device block, while for establishing the second electrical connection the add-on interface comprises further signal connector(s) attachable to corresponding further signal connector(s) of the extension interface of a base HVAC device block.

It is a further object of embodiments disclosed herein to enable add-on HVAC device blocks to be attached to base HVAC device block(s) configured for digital communication, in particular digital transmission of raw sensor signals generated by the sensor of the base HVAC device block respectively for receipt of digital representations of actuator control signals. It is an even further object of embodiments disclosed herein to enable add-on HVAC device blocks to exchange signals in addition to raw sensor signals generated by the sensor of the base HVAC device block respectively of actuator control signals for driving the actuator of the base HVAC device block. This further object and/or even further object is addressed in that the add-on interface is configured for bidirectional transmission of digital signals between the add-on electronic circuit and the HVAC functional device of the base HVAC device block, in particular using a synchronous serial communication interface, such as an I2C, an SPI. UART and/or a TWI interface.

It is an object of embodiments disclosed herein to enable integration of HVAC field devices assembled by attachment of an add-on HVAC device block to a base HVAC device block-into HVAC systems using a bus communication protocol, such as MP Bus, BACnet, KNX or Modbus. This object is addressed in that the add-on interface is configured for bidirectional transmission of digital signals between the add-on electronic circuit and the external electrical interface of the base HVAC device block, such as digitally represented actuator data signals or digital representation of processed sensor data.

It is an object of embodiments disclosed herein to enable integration of HVAC field devices into (legacy) HVAC systems using analog communication. This object is addressed in that the add-on interface comprises an analog input and an analog output for analog signals between the add-on electronic circuit and the external electrical interface of the base HVAC device block. Correspondingly, the add-on electronic circuit is configured to convert analog signals (received/transmitted via the external electrical interface) between digital communication protocols and analog communication protocols supported by the electronic circuit of the base HVAC device block.

It is a further object of embodiments disclosed herein to enable add-on HVAC device blocks to be attached to base HVAC device block(s) capable only of generating respectively receiving analog signals, such as passive sensors providing raw sensor signals as an analogue signal (e.g. current and/or voltage levels proportionate to a measured physical parameter) respectively actuators configured to receive analog representations of actuator control signal (e.g. current and/or voltage levels proportionate to position, driving speed of an actuator). This object is addressed in that the further signal connector(s) of the add-on interface are further configured for bidirectional transmission of analog signals between the add-on electronic circuit and the HVAC functional device of the base HVAC device block. Such embodiments provide the advantage that advanced processing functionalities may be provided—by attachment of an add-on HVAC device block—even to (legacy) HVAC base device blocks using analog communication interfaces.

The present disclosure is advantageous as the base HVAC device block can be flexibly deployed by itself, but its functionalities being extendible by attaching an add-on HVAC device block, in particular by stacking. Furthermore, the add-on HVAC device block can be deployed with various base HVAC device blocks depending on the specific use case. These advantageous effects greatly improve the versatility of the HVAC device blocks while reducing the number of HVAC field devices that need to be manufactured to cover a wide spectrum of use cases.

The present disclosure is advantageous since depending on the use case, generating signal(s) for controlling the HVAC functional device and/or processing signals generated by the HVAC functional device can be done by either the electronic circuit of the base HVAC device block or the electronic circuit of the add-on HVAC device block—when such is attached.

According to embodiments of the present disclosure, processing sensor data and/or processing actuator data is performed by the add-on HVAC device block by an application specific integrated circuit ASIC or a uC (microcontroller) (pre)configured for the particular HVAC functionality(s). Alternatively, or additionally, processing sensor data and/or processing actuator data is provided by the add-on electronic circuit using computer readable instructions executable by a processor of the add-on electronic circuit, for example a fully configurable uC (microcontroller).

According to embodiments disclosed herein, the interfaces are configured such as to align adjacent HVAC device blocks upon the HVAC device blocks being stacked. For a better aligning effect, according to embodiments, the interface(s) are tapered at their outer surfaces.

According to embodiments of the present disclosure, the interfaces comprise a recess, in particular a circumferential recess arranged on a first side of the housing of the respective HVAC device block respectively a corresponding (mating) protrusion, in particular a circumferential protrusion arranged on a second side of the housing of the respective HVAC device block.

According to embodiments disclosed herein, the interface(s) are configured to mutually interlock by an interface-fit upon the HVAC device blocks being stacked to thereby fixedly attach the plurality of HVAC device blocks to each other. The term fixedly attaching, as used herein, refers to attaching such that a release force is required to separate the fixedly attached HVAC device blocks, the release force exceeding forces applied to the HVAC device blocks under normal operation of the HVAC field device and/or the release force acting in a direction/manner different from forces applied on the HVAC device blocks under normal operation of the HVAC field device.

According to even further embodiments, an adhesive and/or fastening means is provided to the interfaces for fixedly attaching the plurality of HVAC device blocks to each other upon being stacked. According to embodiments of the present disclosure, the fastening means comprise latches, screws or bolts in order to mechanically connect the adjacent HVAC device blocks. Alternatively, or additionally, the HVAC device blocks are welded together after being stacked, in particular by ultrasonic welding or laser welding.

According to the specific requirements on the HVAC field device, a sealant is provided at the interfaces to seal the HVAC device blocks together, with respect to humidity, dust or other sources of contamination.

In order to provide additional or redundant power supply, embodiments of the add-on HVAC device block further comprise an add-on external electrical interface arranged on the housing for the transmission of electrical power, the add-on external electrical interface being connected to the add-on electronic circuit.

In order to provide additional or redundant data signal connectivity, embodiments of the add-on HVAC device block further comprise an add-on external electrical interface arranged on the housing for the transmission of data signal(s), the add-on external electrical interface being connected to the add-on electronic circuit.

It is an objective of further embodiments to extend the HVAC functionalities of a base HVAC device block so that data signal(s) and transmission of electrical power share the same electrical connections (Power-line communication PLC). This further objective is addressed in that the add-on interface of the add-on HVAC device block is configured for transmission of data signal(s) and transmission of electrical power over same electrical connections, the add-on HVAC device block further comprising a power supply unit. The power supply unit of the add-on HVAC device block is configured to transfer data signal(s) between the add-on interface and the add-on electronic circuit and to transfer electrical power from the add-on interface to the add-on electronic circuit. In particular, the transfer of data signal(s) between the add-on interface and the add-on electronic circuit by the power supply unit comprises demodulation of data signal(s) carried by power-line connections/modulation of data signal(s) to be then carried by power-line connections. The data signals being modulated/demodulated by the power supply unit of the add-on HVAC device block, the HVAC device blocks (both base and add-on) can provide the respective HVAC functionalities as if the transmission of data signal(s) and transmission of electrical power would be on dedicated connections.

It is an object of further embodiments of the present disclosure to enable a plug-and-play manufacture/assembly of HVAC device blocks into an HVAC field device. This further object is addressed according to the present disclosure by implementing an exchange of configuration data between the HVAC device blocks. Configuration data is stored in the electronic circuit of a first of the plurality of HVAC device blocks (add-on HVAC device block or base HVAC device block) while its electronic circuit is configured to transmit configuration data through the extension interface of the first of the plurality of HVAC device blocks. Furthermore, the electronic circuit of a second of the plurality of HVAC device blocks, different from the first of the plurality of HVAC device blocks, is configured to receive configuration data through its add-on interface. The configuration data is transferred from the first of the plurality of stacked HVAC device blocks to the second and further HVAC device blocks for example upon the HVAC field device being supplied with electrical power. Alternatively, or additionally, the HVAC device blocks are configured such as to exchange configuration data upon the HVAC device blocks being stacked. Alternatively, or additionally, the HVAC device blocks are configured such as to exchange configuration data upon receipt of a command, e.g. as a data signal received via the external electrical interface.

Exchanging configuration data between the HVAC device blocks is advantageous since it allows the HVAC device blocks of an HVAC field device to be automatically configured. In case of HVAC field devices comprising more than two HVAC device blocks, the configuration data from one HVAC device block can be transferred even to not directly adjacent HVAC device blocks by means of step by step propagation between adjacent HVAC device blocks. Also, according to embodiments disclosed herein, the transfer, respectively receipt of configuration data is reciprocal, namely in that each HVAC device block is configured to both transmit and receive configuration data.

According to embodiments disclosed herein, the one or more add-on HVAC device block(s) comprise one or more of:
A processing device, such as a microcontroller or application specific integrated circuit ASIC for providing computing power to the HVAC field device;
A controller device, implementing HVAC control functions, such as a proportional P, a proportional-integral PI, a proportional-integral-derivative PID, an integral I and/or a neural network based control;
A communication device, comprising a wired communication interface and/or a radio communication device—for providing communication functionalities to the HVAC field device. In particular, the communication device comprises one or more of:
   A wired communication interface (such as an Ethernet, in particular a Power over Ethernet PoE, Single Pair Ethernet SPE, a BUS, in particular an MP Bus, BACnet, KNX or Modbus interface);
   A Wide Area Network communication circuit (such as GSM, LTE, 3G, 4G or 5G mobile communications circuit);
   A Low Power Wide Area Network (such as Narrowband Internet of Things NB-IoT, Long Range LoRa/LoRaWAN, SigFox, or Long Term Evolution Category M1 LTECatM1);
   A local area network communication circuit (such as Wireless LAN);
   A short range wireless communication circuit (such as Bluetooth, Bluetooth low energy BLE, Ultra-wideband UWB, Thread and/or Zigbee); and/or
   A close-range wireless communication circuit (such as Radio Frequency Identification RFID or a Near Field Communication NFC).
An energy storage device, comprising a capacitive storage device and/or an electro-chemical storage device;
A sensor device, comprising one or more sensors for the measurement of a parameter of an HVAC system and/or of an environmental parameter (such as temperature, humidity, etc.);

An HVAC interface device, comprising a mechanical interface to a damper and/or pipe of an HVAC system;
A position feedback device of the actuated part;
An electrical power supply device, for providing external electrical power to the HVAC field device, such as universal power supply devices (24 VAC to 250 VAC/24 VDC-125VDC), or power supply devices for specific supply voltages;
A monitoring/service device, for performing specific service and data logging function(s); and/or
A display device.

Add-on HVAC device blocks according to embodiments disclosed herein may be grouped into several levels:
Level 2 HVAC device blocks comprise a uC (microcontroller) (pre)configured for application-specific extension of the functionality of the base HVAC device block, such as for executing a program code of at least a specific HVAC application, such as Variable Air Volume VAV control based on data signals from a sensor for the measurement of an air flow. Furthermore, Level 2 HVAC device blocks support various communication protocols such as ModBus or BACnet on different physical layers such as RS485, Ethernet, in particular Power over Ethernet PoE and/or Single Pair Ethernet SPE;
Level 3 HVAC device blocks comprise a uC (microcontroller) fully configurable for advanced HVAC functions and/or similar functionality as the Level 2 HVAC device blocks.

According to embodiments of the present disclosure, the add-on HVAC device block extends the functionality of the base HVAC device block with the capability of being powered through the add-on HVAC device block. In order to provide this HVAC functionality, the add-on HVAC device block comprises a power interface and a power converter. The power interface is configured for being connectable to a power supply. The power converter is configured for transmitting electrical power from the power interface to the add-on HVAC device block and/or the base HVAC device block.

In particular, according to a further embodiment, the add-on HVAC device block extends the functionality of the base HVAC device block with the capability of being powered by an AC power supply, such as mains power supply of 230V. In order to provide this HVAC functionality, the power interface of the add-on HVAC device block is an AC interface for connecting an AC power supply, such as a 230V power supply connected to an AC/DC power converter. The AC/DC power converter of the add-on HVAC device block is configured to convert the AC power supplied through the AC interface to a low voltage DC power (such as 24V) and provide such low voltage DC power to the HVAC device blocks, in particular to the electric circuit of the base HVAC device block and the electronic circuit of the add-on HVAC device block. Such embodiment is advantageous since the other HVAC device blocks (other than the add-on HVAC device block having the AC power interface) do not have to be provided with the protective measures required for AC power supply (such as more robust wiring and/or insulation).

Alternatively, or additionally, the add-on HVAC device block extends the functionality of the base HVAC device block with the capability of being powered by a power over Ethernet connection. In order to provide this HVAC functionality, the power interface of the add-on HVAC device block is a power over Ethernet interface. The power converter of the add-on HVAC device block is a power over Ethernet converter, configured to transfer electrical power supplied through the power over Ethernet interface to the electric circuit of the base HVAC device block and the electronic circuit of the add-on HVAC device block.

The present disclosure further relates to an HVAC field device comprising a base HVAC device block, according to one of the embodiments disclosed herein, and an add-on HVAC device block according to one of the embodiments disclosed herein, the add-on HVAC device block being attached to the base HVAC device block so that the add-on interface is connected with the extension interface for transmission of electrical power and data signal(s).

The present disclosure further relates to a method of operating an HVAC field device. In a preparatory step, a base HVAC device block comprising an extension interface, an external electrical interface, and an HVAC functional device comprising a sensor and/or an actuator is provided. In a further preparatory step, an add-on HVAC device block—according to one of its embodiments disclosed herein—is provided. Following the preparatory steps, the add-on HVAC device block is attached to the base HVAC device block. Following attachment of the add-on HVAC device block to the base HVAC device block, the add-on HVAC device block is caused to operate in a sensor operation mode with a base HVAC device block having an HVAC functional device comprising a sensor configured to measure a parameter of an HVAC system; and/or
in an actuator operation mode with a base HVAC device block having an HVAC functional device comprising an actuator for actuating a mechanically attached actuated part.

According to embodiments of the method of operating an HVAC field device, in a further preparatory step, the add-on electronic circuit is provided with computer readable instructions comprising a sensor command set and/or an actuator command set. Alternatively, or additionally, the add-on electronic circuit is caused to retrieve computer readable instructions comprising a sensor command set and/or an actuator command set from a memory device internal or communicatively connected to the add-on electronic circuit. Alternatively, or additionally, the sensor command set and/or the actuator command set are provided to/retrieved by the add-on electronic circuit via a communication interface of the add-on HVAC device block from an external computing device, such as a mobile computing device and/or a remote server.

Correspondingly, operating in the sensor operation mode comprises causing the add-on electronic circuit to carry out one or more instructions of the sensor command set such as to receive (using the second electrical connection) and process raw sensor signals generated by the sensor of the base HVAC device block and transmit (using the first electrical) processed raw sensor signals to the external electrical interface of the base HVAC device block. On the other hand, operating in the actuator operation mode comprises causing the add-on electronic circuit to carry out one or more instructions of the actuator command set such as to receive (using the first electrical connection) and process actuator data signals from the external electrical interface of the base HVAC device block, to generate actuator control signals for operating the actuator of the base HVAC device block, and to transmit (using the second electrical connection) actuator control signals to the actuator of the base HVAC device block.

The present disclosure further relates to a computer program product comprising computer-readable instructions, which, when carried out by an add-on electronic circuit of an add-on HVAC device block, in particular a processor of the add-on electronic circuit, according to one of the embodiments disclosed herein, causes the add-on HVAC device block to operate in a sensor operation mode in conjunction with a base HVAC device block having an HVAC functional device comprising a sensor configured to measure a parameter of an HVAC system; and/or in an actuator operation mode in conjunction with a base HVAC device block having an HVAC functional device comprising an actuator for actuating a mechanically attached actuated part.

According to embodiments, the computer-readable instructions, when carried out by the add-on electronic circuit, cause the add-on HVAC device block to:
activate the sensor operation mode, upon attachment to a base HVAC device block having an HVAC functional device comprising a sensor configured to measure a parameter of an HVAC system; and
activate the actuator operation mode upon attachment to a base HVAC device block having an HVAC functional device comprising an actuator for actuating a mechanically attached actuated part.

According to embodiments, the computer-readable instructions further comprise a sensor command set and an actuator command set, wherein the computer-readable instructions, when carried out by the add-on electronic circuit, cause the add-on HVAC device block to enable the sensor command set and/or the actuator command set in accordance with the sensor operation mode respectively the actuator operation mode.

It is to be understood that both the foregoing general description and the following detailed description present embodiments, and are intended to provide an overview or framework for understanding the nature and character of the disclosure. The accompanying drawings are included to provide a further understanding, and are incorporated into and constitute a part of this specification. The drawings illustrate various embodiments, and together with the description serve to explain the principles and operation of the concepts disclosed.

### BRIEF DESCRIPTION OF THE DRAWINGS

The herein described disclosure will be more fully understood from the detailed description given herein below and the accompanying drawings which should not be considered limiting to the disclosure described in the appended claims. The drawings which show:

FIG. 1: a highly schematic block diagram of a base HVAC device block according to the present disclosure;

FIG. 2: a highly schematic block diagram of an embodiment of the add-on HVAC device block according to the present disclosure;

FIG. 3: a highly schematic block diagram of a further embodiment of the add-on HVAC device block according to the present disclosure, configured to receive further add-on HVAC device block(s);

FIG. 4: a highly schematic block diagram of an embodiment of the HVAC field device according to the present disclosure; assembled by stacking an add-on HVAC device block and a base HVAC device block;

FIG. 5: a highly schematic block diagram of a further embodiment of the HVAC field device according to the present disclosure; configured for Power-Line Communication;

FIG. 6: a highly schematic block diagram of a further embodiment of the HVAC field device according to the present disclosure; configured for being powered though an AC connection of an add-on HVAC device block;

FIG. 7: a flow chart depicting steps of a method of operating an HVAC field device according to the present disclosure; and

FIG. 8: a schematic block diagram of an HVAC system, comprising an HVAC field device according to the present disclosure.

### DETAILED DESCRIPTION

Reference will now be made in detail to certain embodiments, examples of which are illustrated in the accompanying drawings, in which some, but not all features are shown. Indeed, embodiments disclosed herein may be embodied in many different forms and should not be construed as limited to the embodiments set forth herein; rather, these embodiments are provided so that this disclosure will satisfy applicable legal requirements. Whenever possible, like reference numbers will be used to refer to like components or parts.

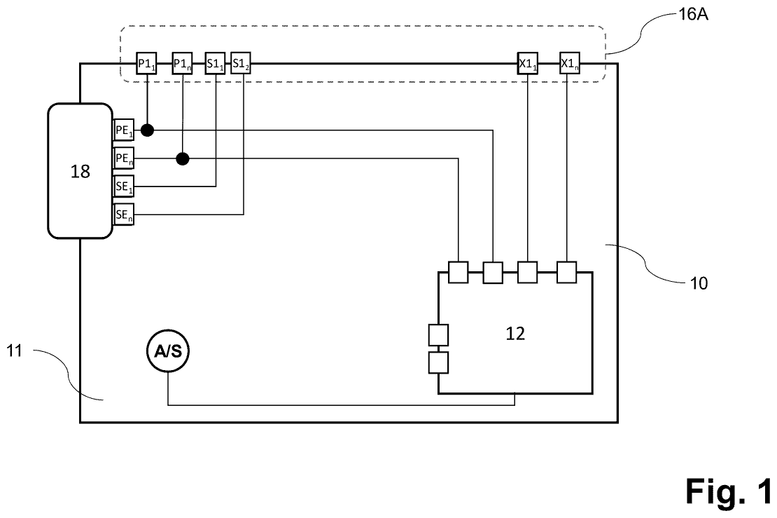

FIG. 1 shows a highly schematic block diagram of an embodiment of a base HVAC device block 10 according to the present disclosure. As shown on the figure, the base HVAC device block 10 comprises a housing 11; an HVAC functional device A/S; an extension interface 16A; an external electrical interface 18 arranged on the housing 11; and an electronic circuit 12 such as an analog/digital converter for converting analog signals generated by/received by the HVAC functional device A/S into digital representations thereof.

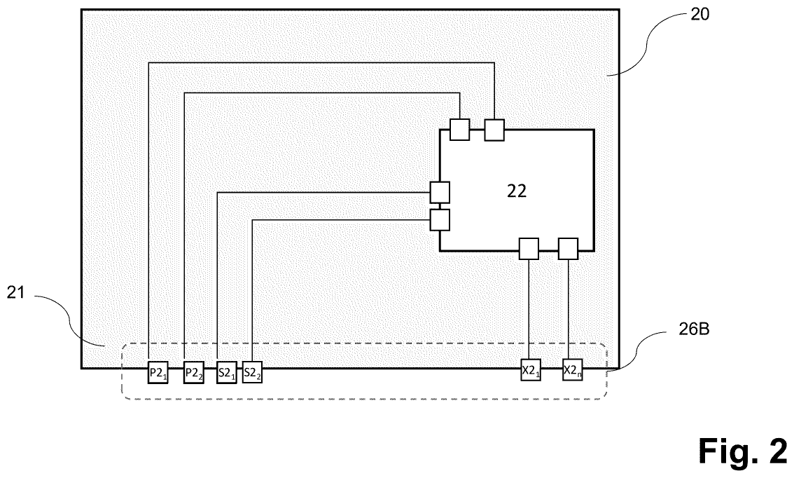

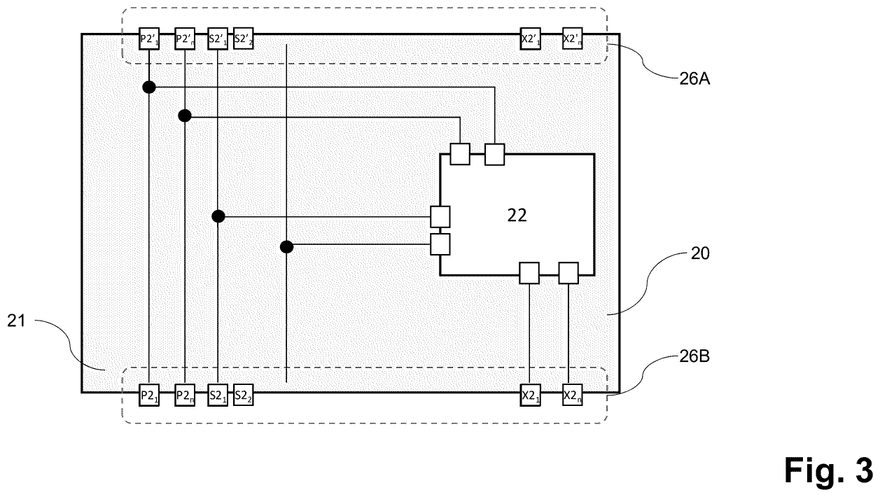

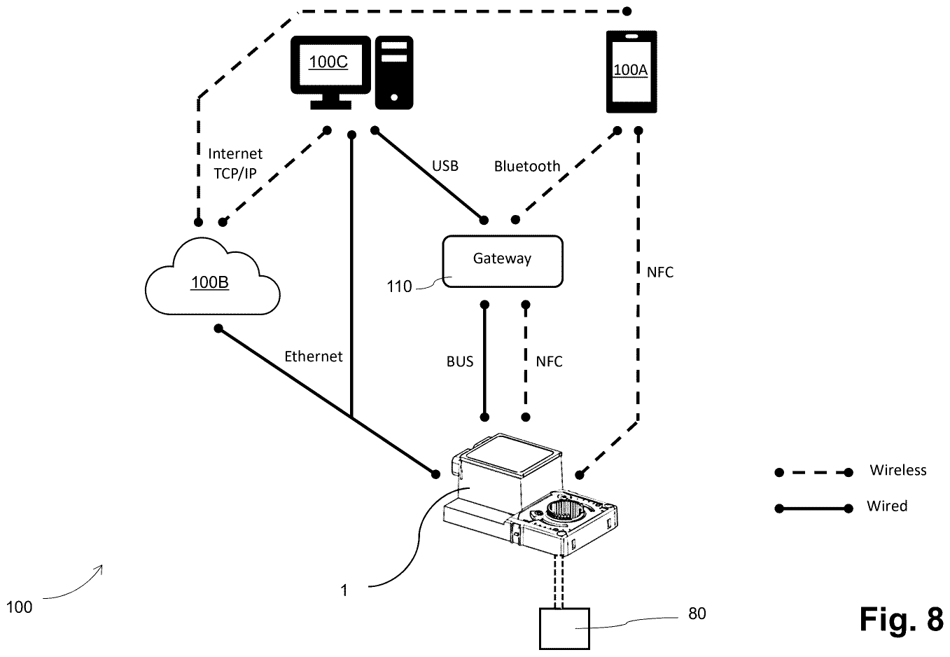

The HVAC functional device A/S comprises an actuator A such as an electric motor arranged within the housing 11 to drive an actuated part (located outside the housing 11). Alternatively, or additionally the HVAC functional device A/S comprises a sensor S. The sensor S is arranged within the housing 11. Alternatively, or additionally, the sensor S is arranged outside the housing 11 and communicatively connected to the base HVAC device block 10. The sensor S of the base HVAC device block 10 is configured to measure a parameter of the HVAC system, in particular an environmental parameter, such as a temperature, humidity, particulate matter PM and/or CO2 level of an environment controlled by the HVAC system. Alternatively, or additionally, the sensor S of the base HVAC device block is provided to measure operational parameters of various components of the HVAC system 100 such as an actuated position of the actuated part 80 and/or the operational state of the HVAC field device 1 and/or other parameters of the HVAC system 100 (see FIG. 8), such as a flow rate or differential pressure at locations of a liquid through a fluid transportation system. The extension interface 16A is arranged on the housing 11 and provided to accommodate an add-on HVAC device block 20 (see FIGS. 2 and 3), in particular by stacking, by connecting to a counterpart add-on interface of the add-on HVAC device block. The external electrical interface 18, also arranged on the housing 11, is configured for the transmission of both electrical power and data signal(s). The electronic circuit 12 is connected with the HVAC functional device A/S.

According to the embodiment shown on the FIGS. 1 to 6, the external electrical interface 18 and the extension interface 16A of the base HVAC device block 10 each comprise external signal connectors SE₁₋ₙ respectively signal connectors S1₁₋ₙ for the transmission of electrical signals and external power connectors PE₁₋ₙ respectively power connectors P1₁₋ₙ for the transmission of electrical power. In order to supply it with electricity, the electronic circuit 12 is connected with the external power connectors PE₁₋ₙ of the external electrical interface 18. In order to power an attached add-on HVAC device block 20, the power connectors P1₁₋ₙ of the extension interface 16A are connected with the power connector(s) PE₁₋ₙ of its external electrical interface 18.

FIG. 2 shows a highly schematic block diagram of an embodiment of an add-on HVAC device block 20 according to the present disclosure. The add-on HVAC device block 20 comprises a housing 21; an add-on interface 26B; and an add-on electronic circuit 22 connected with the add-on interface 26B. The add-on HVAC device block 20 is configured to be attached—in particular by stacking (on top of each other or side by side)—to a base HVAC device block 10 according to one of the embodiments disclosed herein. In particular, the add-on interface 26B is arranged on the housing 21 such that it connects with the extension interface 16A of the base HVAC device block 10 when the add-on HVAC device block 20 is attached to the base HVAC device block 10.

The add-on electronic circuit 22 is configured to extend the functionality of a base HVAC device block 10. In particular, the add-on electronic circuit 22 provides data signal processing capabilities not supported by the electronic circuit 12 of the base HVAC device block 10.

As it can be seen, the add-on HVAC device block 20 is constructed correspondingly to the base HVAC device block 10, in particular, the add-on interface 26B is constructed as a counterpart of the extension interface 16A of the base HVAC device block 10. According to the embodiment shown on the FIGS. 2 to 6, the add-on interface 26B comprises signal connector(s) S2₁₋ₙ attachable to corresponding signal connector(s) S1₁₋ₙ of the extension interface 16A of a base HVAC device block 10 for establishing the first electrical connection and further signal connector(s) X2₁₋ₙ attachable to corresponding further signal connector(s) X1₁₋ₙ of the extension interface 16A of a base HVAC device block 10 for establishing the second electrical connection. In order to supply the add-on HVAC device block 20 it with electricity, the add-on interface 26B comprises power connectors P2₁₋ₙ for the transmission of electrical power, the electronic circuit 12 being connected with the power connectors P₁₋ₙ of the add-on interface 26B.

In order to enable the extension of the HVAC functionalities of a base HVAC device block 10 by HVAC functionalities of more than one add-on HVAC device blocks 20, as shown on FIG. 3, according to embodiments disclosed herein, the add-on HVAC device block 20 further comprises a second add-on interface 26A arranged on the housing 21, in particular on a side of the housing 21 opposite the side where the add-on interface 26B is arranged. The second add-on interface 26A is connected with the add-on interface 26B for the transmission of electrical power and data signal(s), wherein the second add-on interface 26A is configured to be able to receive one or more further add-on HVAC device block(s) 20. According to embodiments of the present disclosure, the second add-on interface 26A is constructed identical to the extension interface 16A of the base HVAC device block 10. The second add-on interface 26A comprises signal connectors S2′₁₋ₙ and further signal connectors X2′₁₋ₙ for the transmission of electrical signals and power connectors P2′₁₋ₙ for the transmission of electrical power.

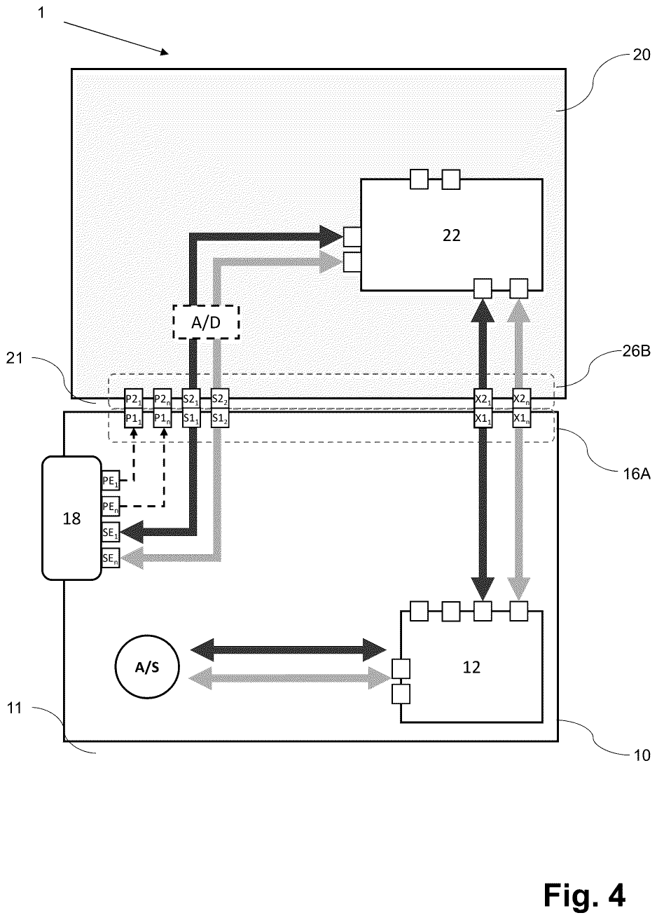

Turning now to FIG. 4, a HVAC field device 1 according to the present disclosure shall be described. As illustrated, the HVAC field device 1 is assembled by stacking an add-on HVAC device block 20 and a base HVAC device block 10, such that the add-on interface 26B of the add-on HVAC device block 20 is connected with the extension interface 16A of the base HVAC device block 10 for transmission of electrical power and data signal(s).

FIG. 4 illustrates the operation of the base HVAC device block 10, and thereby of the entire HVAC field device 1. The add-on HVAC device block 20 is configured such as to establish, upon attachment of the add-on interface 26B to the extension interface 16A of the base HVAC device block 10 a first electrical connection (shown on the figures with a thick dark grey line) between the add-on electronic circuit 22 and the external electrical interface 18 of the base HVAC device block 10. As illustrated, the first electrical connection is established by mating of signal connector(s) S2₁₋ₙ of the add-on interface 26B of the add-on HVAC device block 20 with corresponding signal connector(s) S1₁₋ₙ of the extension interface 16A of a base HVAC device block 10.

Furthermore, the add-on HVAC device block 20 is configured such as to establish, upon attachment of the add-on interface 26B to the extension interface 16A of the base HVAC device block 10, a second electrical connection (shown on the figures with a thick light grey line) between the add-on electronic circuit 22 and an HVAC functional device A/S of the base HVAC device block 10. As illustrated, the second electrical connection is established by mating of the further signal connector(s) X2₁₋ₙ of the add-on interface 26B of the add-on HVAC device block 20 with corresponding further signal connector(s) X1₁₋ₙ of the extension interface 16A of a base HVAC device block 10.

The first electrical connection in combination with the second electrical connection enable routing of data communication between the external electrical interface 18 and HVAC functional device A/S of the base HVAC device block 10 through the add-on electronic circuit 22.

In order to enable a flexible deployment—either as part of a sensor or an actuator—the add-on HVAC device block 20 is configured to be operable in a sensor operation mode and/or an actuator operation mode. The add-on HVAC device block 20 is operable in the sensor operation mode for operation with a base HVAC device block 10 having an HVAC functional device A/S comprising and/or communicatively connected to a sensor S configured to measure a parameter of an HVAC system 100. The add-on HVAC device block 20 is operable in the actuator operation mode for operation with a base HVAC device block 10 having an HVAC functional device A/S comprising an actuator A for actuating a drivingly attached actuated part. Hence, the add-on HVAC device block 20 attached to a base HVAC device block 10 forms an HVAC field device 1 of a sensor type and/or of an actuator type.

The routing of the data signal(s) through the add-on electronic circuit 22 of the add-on HVAC device block 20 is accomplished via an add-on interface 26B of the add-on HVAC device block 20, corresponding to and connected to the extension interface 16A of the base HVAC device block 10. As shown on FIG. 4, when the add-on HVAC device block 20 is stacked onto the base HVAC device block 10, the signal connectors S1₁₋ₙ, the power connectors P1₁₋ₙ of the extension interface 16A are connected to the signal connectors S2₁₋ₙ the power connectors P2x-n of the add-on interface 26B, respectively.

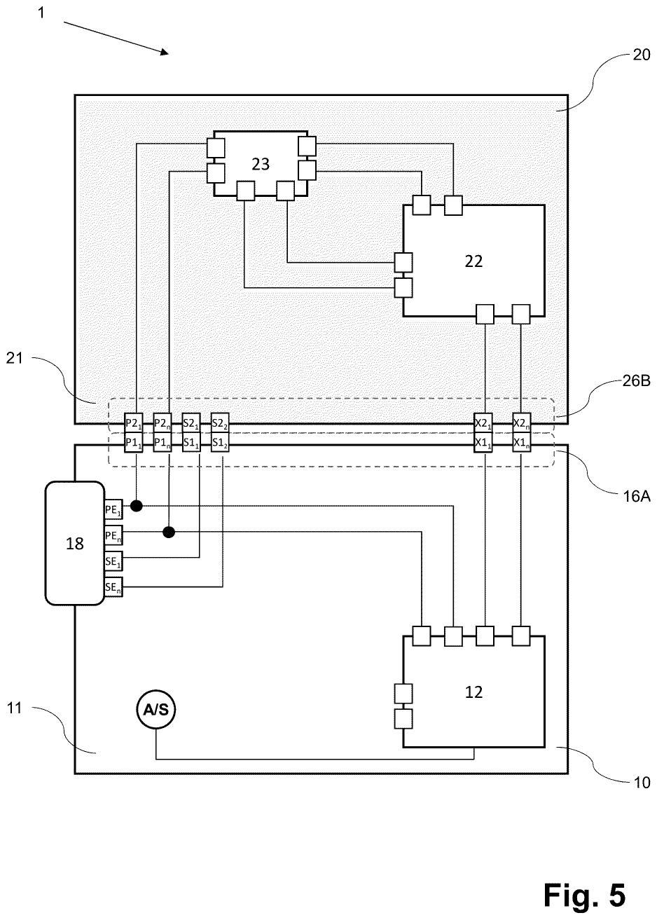

FIG. 5 shows a highly schematic block diagram of a further embodiment of the HVAC field device 1 according to the present disclosure, wherein the add-on HVAC device block 20 extends the functionality of the base HVAC device block 10 with the capability of Power-Line Communication. In order to add Power Line Communication capabilities, the add-on HVAC device block 20 comprises a power supply unit 23. The power supply unit 23 is provided to “separate” transfer of data signal(s) from transfer of electrical power. On one hand, the power supply unit 23 transfers data signal(s) between power connectors P2x-n of the add-on interface 26B and signal connectors of the add-on electronic circuit 22. On the other hand, the power supply unit 23 transfers electric power from the same power connectors P2x-n of the add-on interface 26B to power connectors of the add-on electronic circuit 22. The transfer of data signal(s) between power connectors P2x-n of the add-on interface 26B and signal connectors of the add-on electronic circuit 22 by the power supply unit 23 comprises demodulation of data signal(s) carried by power-line connections/modulation of data signal(s) to be then carried by power-line connections. The data signals being modulated/demodulated by the power supply unit 23 of the add-on HVAC device block 20, the HVAC device blocks (both base and add-on) can provide the respective HVAC functionalities as if the transmission of data signal(s) and transmission of electrical power would be on separate power and signal connections.

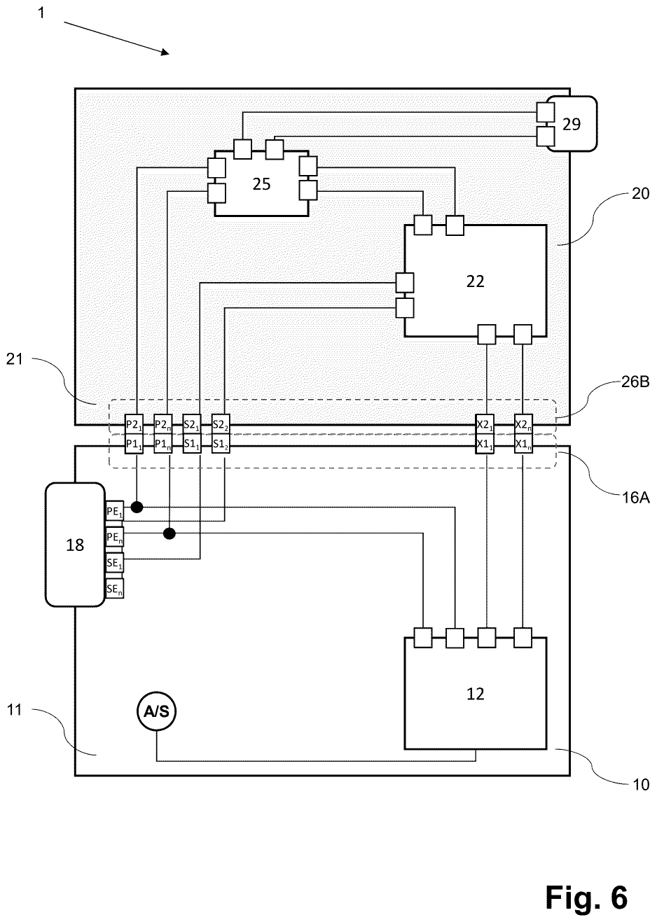

FIG. 6 shows a highly schematic block diagram of a further embodiment of the HVAC field device 1 according to the present disclosure, wherein the add-on HVAC device block 20 extends the functionality of the base HVAC device block 10 with the capability of being powered via the add-on HVAC device block 20, in particular by an AC power supply, such as mains power supply of 230V. In order to provide this HVAC functionality, the add-on HVAC device block 20 comprises an AC power interface 29 for connecting an AC power supply, such as a 230V power supply connected to an AC/DC converter 25. The AC/DC power converter 25 of the add-on HVAC device block 20 is configured to convert the AC power supplied through the AC power interface 29 to a low voltage DC power (such as 24V) and provide such low voltage DC power to the HVAC device blocks 10, 20, in particular to the electric circuit 12 of the base HVAC device block 10 and the electronic circuit 22 of the add-on HVAC device block 20. Such embodiment is advantageous since the other HVAC device blocks (other than the add-on HVAC device block having the AC interface power 29) do not have to be provided with the protective measures required for AC power supply (such as more robust wiring and/or insulation).

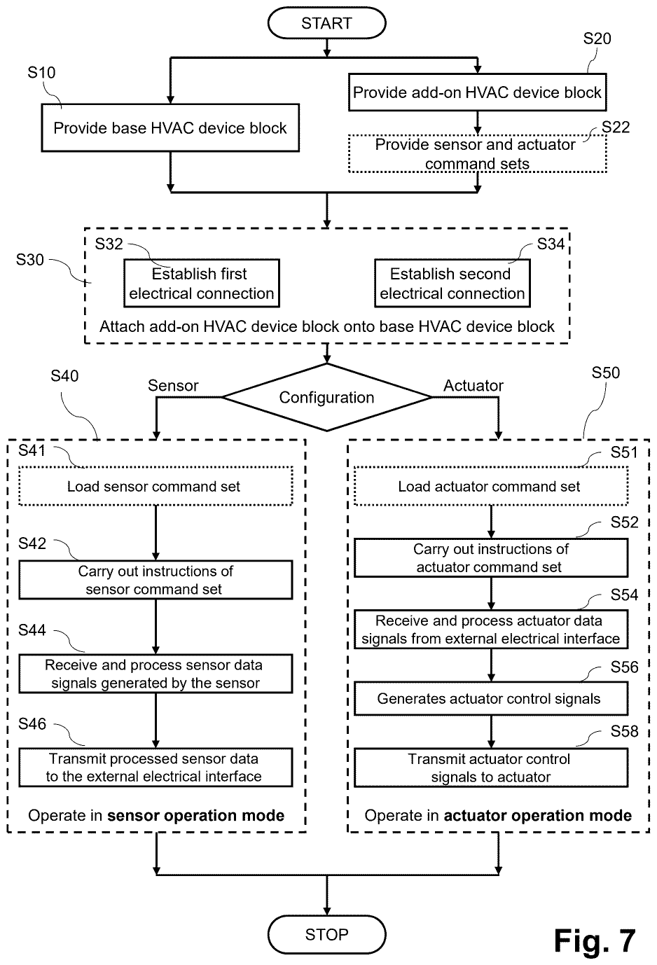

FIG. 7 depicts steps of an embodiment of a method of operating an HVAC field device 1. In a preparatory step S10, a base HVAC device block 10 comprising an extension interface 16A, an external electrical interface 18, and an HVAC functional device A/S comprising a sensor S and/or an actuator A is provided. In a further preparatory step S20, an add-on HVAC device block 20 according to one of its embodiments disclosed herein—is provided.

According to embodiments (shown with dotted lines), in an even further preparatory step S22, the add-on HVAC device block 20 is provided with computer readable instructions comprising a sensor command set and an actuator command set. According to embodiments, the sensor command set and the actuator command set may be provided in a memory device internal or communicatively connected to the add-on electronic circuit. Alternatively, or additionally, the sensor command set and the actuator command set are provided to the add-on electronic circuit via a communication interface of the add-on HVAC device block.

Following the preparatory steps, in a step S30 the add-on HVAC device block 20 is attached to the base HVAC device block 10. In a substep S32—of step S30—upon attachment of the add-on interface 26B to the extension interface 16A of the base HVAC device block 10, a first electrical connection is established between the add-on electronic circuit 22 and the external electrical interface 18 of the base HVAC device block 10. Furthermore, in a substep S34—of step S30—upon attachment of the add-on interface 26B to the extension interface 16A of the base HVAC device block 10, a second electrical connection is established between the add-on electronic circuit 22 and an HVAC functional device A/S of the base HVAC device block 10. The first electrical connection in combination with the second electrical connection enable routing of data communication between the external electrical interface 18 and HVAC functional device A/S of the base HVAC device block 10 through the add-on electronic circuit 22. As part of step S30 the add-on HVAC device block 20 enables a bidirectional data flow between the HVAC functional device A/S and the external electrical interface 18 of the base HVAC device block 10 via the add-on electronic circuit 22.

Following attachment of the add-on HVAC device block 20 to the base HVAC device block 10, the add-on HVAC device block 20 is caused to operate in a sensor operation mode—step S40 with a base HVAC device block 10 having an HVAC functional device A/S comprising a sensor S configured to measure a parameter of an HVAC system 100. Alternatively, or additionally, following attachment of the add-on HVAC device block 20 to the base HVAC device block 10, the add-on HVAC device block 20 is caused to operate in an actuator operation mode—step S50—with a base HVAC device block 10 having an HVAC functional device A/S comprising an actuator A for actuating a mechanically attached actuated part.

According to embodiments disclosed herein, the add-on HVAC device block 20—and hence the HVAC field device 1 is caused to operate in a sensor operation mode or the actuator operating mode by sending a configuration signal to the add-on HVAC device block 20, such as by bringing a corresponding NFC transponder in the proximity of the add-on HVAC device block 20 and/or by manual actuation of an electromechanical switch arranged on the add-on HVAC device block 20. Alternatively, or additionally, according to embodiments disclosed herein, the add-on HVAC device block 20 is configured to activate the sensor operation mode upon attachment to a base HVAC device block 10 having an HVAC functional device A/S comprising and/or communicatively connected to a sensor S configured to measure a parameter of an HVAC system 100 and to activate the actuator operation mode upon attachment to a base HVAC device block 10 having an HVAC functional device A/S comprising an actuator A for actuating a drivingly attached actuated part. Such embodiments are advantageous as they allow a plug-and-play kind of assembly of an HVAC field device without the need for manually switching operation of the add-on HVAC device block in accordance with the type of base HVAC device block. Such in turn speeds up installation time and mitigates the risks of human error. According to embodiments, automatic activation of the sensor operation mode or the actuator operation mode upon attachment of the add-on HVAC device block to a base HVAC device block 10 is achieved in that the add-on electronic circuit 22 is configured to detect whether the HVAC functional device A/S comprises and/or is communicatively connected to a sensor S or whether the HVAC functional device A/S comprises an actuator A. In a first variant, the add-on electronic circuit 22 is configured to transmit an inventory enquiry signal to the base HVAC device block, enquiring whether the HVAC functional device A/S comprises and/or is communicatively connected to a sensor S or whether the HVAC functional device A/S comprises an actuator A. The add-on electronic circuit 22 is further configured to process an inventory response to the inventory enquiry signal from the base HVAC device block, the inventory response comprising data indicative whether the HVAC functional device A/S comprises and/or is communicatively connected to a sensor S or whether the HVAC functional device A/S comprises an actuator A. Alternatively, or additionally, in a second variant, the add-on HVAC device block is configured to interact with electro-mechanical elements of the base HVAC device block (such as encoding protrusions, switching pins or the like), the electro-mechanical elements identifying the respective base HVAC device block as comprising a sensor Soran actuator A.

According to embodiments (shown with dotted lines), in a preparatory substep S41 of step S40, the add-on HVAC device block 20 is caused to receive/retrieve the sensor command set from a memory device internal or communicatively connected to the add-on electronic circuit. Alternatively, or additionally as part of step S40, the add-on HVAC device block is caused to receive/retrieve the sensor command set via a communication interface of the add-on HVAC device block from an external computing device, such as a mobile computing device and/or a remote server.

As part of step S40 of operating in the sensor operation mode, in a substep S42, the add-on electronic circuit 22 is caused to carry out one or more instructions of the sensor command set, such as to receive—using the second electrical connection—and processes (in substep S44) raw sensor signals generated by the sensor S of the base HVAC device block 10 and (in a substep S46) transmit processed sensor data (also referred to as interpreted data) signals to the external electrical interface 18 of the base HVAC device block 10 using the first electrical connection.

According to embodiments (shown with dotted lines), in a preparatory substep S51 of step S50, the add-on HVAC device block 20 is caused to receive/retrieve the actuator command set from a memory device internal or communicatively connected to the add-on electronic circuit. Alternatively, or additionally as part of step S50, the add-on HVAC device block is caused to receive/retrieve the actuator command set via a communication interface of the add-on HVAC device block from an external computing device, such as a mobile computing device and/or a remote server.

As part of step S50 of operating in the actuator operation mode, in a substep S52, the add-on electronic circuit 22 is caused to carry out one or more instructions of the actuator command set, such as to receive—using the first electrical connection—and processes (in substep S54) actuator data signals from the external electrical interface 18 of the base HVAC device block 10 and (in substep S56) generate actuator control signals for operating the actuator A of the base HVAC device block 10. Thereafter, in a substep S58, the add-on electronic circuit 22 transmits actuator control signals to the actuator A of the base HVAC device block 10 using the second electrical connection.

Turning now to FIG. 8, an HVAC system 100 shall be described, comprising an HVAC field device 1 according to the present disclosure. The HVAC system 100 comprises one or more external computing devices 100A-C, such as a remote server 100B communicatively connected with the HVAC field device 1 using a radio communication circuit of one or more of the add-on HVAC device block(s) 20. Additionally, or alternatively, the HVAC field device 1 is configured to establish a communication link with a mobile computing device 100A using radio communication circuits of one or more of the add-on HVAC device block(s) 20, in particular a Near Field Communication NFC and/or a Bluetooth Low Energy BLE and/or a Wireless Local Area Network WLAN communication circuit. The HVAC field device 1 is further connectable (using communication circuits and/or the external electrical interface 18 or through one or more of the add-on HVAC device block(s) 20 to a control terminal 100C, such as a computer running a Building Management System BMS, either directly or via a gateway device 110 using a wired (such as a BUS connection) or a wireless connection (such as NFC). Connecting the HVAC field device 1 to one more external computing devices 100A-C, is achieved in particular by operating the base HVAC device block 10 in the second configuration, whereby one or more add-on HVAC device block(s) 20 provide the HVAC functionalities of connecting said one more external computing devices 100A-C. According to a particular embodiment, the gateway device 110 is comprised by an add-on HVAC device block 20.

### LIST OF REFERENCE NUMERALS

HVAC field device 1
HVAC device blocks 10, 20
base HVAC device block 10
   electronic circuit 12
   extension interface 16A
   external electrical interface (of base HVAC device block) 18
   external signal connectors (of external electrical interface of base HVAC device block) SE₁₋ₙ
   external power connectors (of external electrical interface of base HVAC device block) PE₁₋ₙ
   signal connectors (of base HVAC device block) S1₁₋ₙ
   further signal connectors (of base HVAC device block) X1₁₋ₙ
   power connectors (of base HVAC device block) P1₁₋ₙ
   HVAC functional device A/S
   actuator (of base HVAC device block) A
   sensor (of base HVAC device block) S
add-on HVAC device block 20
   housing (of add-on HVAC device block) 21
   add-on electronic circuit (of add-on HVAC device block) 22
   power supply unit 23
   power converter 25
   an add-on interface 26B
   second add-on interface 26A
   power interface 29
   signal connectors (of add-on HVAC device block) S2₁₋ₙ
   further signal connectors (of add-on HVAC device block) X2₁₋ₙ
   power connectors (of add-on HVAC device block) P2₁₋ₙ
actuated part 80
HVAC system 100
external computing devices 100A-C
mobile computing device 100A
remote server 100B
control terminal 100C
gateway device 110

1: An add-on HVAC device block for attachment to a base HVAC device block having an HVAC functional device, the HVAC functional device comprising and/or communicatively connected to a sensor and/or an actuator configured to measure respectively regulate a parameter of a fluid in a fluid transportation system,
the add-on HVAC device block comprising:
a housing;
an add-on electronic circuit arranged within the housing and
an add-on interface arranged on the housing
wherein:
the add-on HVAC device block is configured to establish, upon attachment of the add-on interface to an extension interface of a base HVAC device block:
a first electrical connection between the add-on electronic circuit and an external electrical interface of the base HVAC device block; and
second electrical connection between the add-on electronic circuit and an HVAC functional device of the base HVAC device block;
the add-on HVAC device block is configured to be operable in:
a sensor operation mode, for operation with a base HVAC device block having an HVAC functional device comprising and/or communicatively connected to a sensor configured to measure a parameter of an HVAC system; and
an actuator operation mode for operation with a base HVAC device block having an HVAC functional device comprising an actuator for actuating a drivingly attached actuated part.

2: The add-on HVAC device block according to claim 1, wherein:
in the sensor operation mode, the add-on electronic circuit is configurable to carry out one or more instructions of a sensor command set to:
receive raw sensor signals generated by the sensor of the base HVAC device block using the second electrical connection;
process the raw sensor signals; and
transmit processed sensor signals to the external electrical interface of the base HVAC device block using the first electrical connection; and
in the actuator operation mode, the add-on electronic circuit is configurable to carry out one or more instructions of an actuator command set to:
receive actuator data signals from the external electrical interface of the base HVAC device block using the first electrical connection;
process actuator data and generate actuator control signals for operating the actuator of the base HVAC device block, and
transmit actuator control signals to the actuator of the base HVAC device block using the second electrical connection.

3: The add-on HVAC device block according to claim 2, wherein the add-on HVAC device block is configured to retrieve the sensor command set and/or the actuator command set in accordance with the sensor operation mode respectively the actuator operation mode.

4: The add-on HVAC device block according to claim 2, wherein in the sensor operation mode, processing raw sensor signals comprises converting signals generated by the sensor into signals representative of and/or derived from one or more parameters measured by the sensor.

5: The add-on HVAC device block according to claim 2, wherein in the actuator operation mode, processing actuator data signals comprises converting signals from the external electrical interface of the base HVAC device block into actuator control signals for driving the actuator.

6: The add-on HVAC device block according to claim 1, wherein the add-on interface is configured for bidirectional transmission of digital signals between the add-on electronic circuit and the HVAC functional device of the base HVAC device block.

7: The add-on HVAC device block according to claim 6, wherein:
the add-on interface is configured for bidirectional transmission of digital signals between the add-on electronic circuit and the external electrical interface of the base HVAC device block; and/or
the add-on interface comprises an analog input and an analog output for analog signals between the add-on electronic circuit and the external electrical interface of the base HVAC device block.

8: The add-on HVAC device block according to claim 1, wherein the add-on interface comprises a synchronous serial communication interface.

9: The add-on HVAC device block according to claim 1, wherein the add-on interface comprises power connector(s) for the transmission of electrical power configured to be attachable to corresponding power connector(s) of the extension interface of a base HVAC device block for at least partially supplying the add-on HVAC device block with electrical power supplied via the external electrical interface of the base HVAC device block.

10: The add-on HVAC device block according to claim 1, wherein, the add-on HVAC device block is configured to:
activate the sensor operation mode, upon attachment to a base HVAC device block having an HVAC functional device comprising and/or communicatively connected to a sensor configured to measure a parameter of an HVAC system; and
activate the actuator operation mode upon attachment to a base HVAC device block having an HVAC functional device comprising an actuator for actuating a drivingly attached actuated part.

11: The add-on HVAC device block according to claim 1, further comprising a communication interface,
wherein the add-on HVAC device block is configured to receive the sensor command set and/or the actuator data set via the communication interface.

12: An HVAC field device comprising:
an add-on HVAC device block according to claim 1;
base HVAC device block comprising an extension interface; an external electrical interface; and an HVAC functional device comprising and/or communicatively connected to a sensor and/or an actuator configured to measure respectively regulate a parameter of a fluid in a fluid transportation system,
the add-on HVAC device block being attached to the base HVAC device block so that the add-on interface of the add-on HVAC device block is connected with the extension interface of the HVAC device block.

13: A method of operating an HVAC field device, comprising:
providing a base HVAC device block comprising an extension interface, an external electrical interface, and an HVAC functional device comprising and/or communicatively connected to a sensor and/or an actuator configured to measure respectively regulate a parameter of a fluid in a fluid transportation system;
providing an add-on HVAC device block according to claim 1;
attaching the add-on HVAC device block to the base HVAC device block; and
causing the add-on HVAC device block to operate:
in a sensor operation mode with a base HVAC device block having an HVAC functional device comprising a sensor configured to measure a parameter of an HVAC system; and/or
in an actuator operation mode with a base HVAC device block having an HVAC functional device comprising an actuator for actuating a mechanically attached actuated part.

14: The method according to claim 13, further comprising:
in the sensor operation mode, causing the add-on electronic circuit to carry out one or more instructions of a sensor command set to:
receive raw sensor signals generated by the sensor of the base HVAC device block using the second electrical connection;
process the raw sensor signals; and
transmit processed sensor signals to the external electrical interface of the base HVAC device block using the first electrical connection; and
in the actuator operation mode, causing the add-on electronic circuit to carry out one or more instructions of an actuator command set as-to:
receive actuator data signals from the external electrical interface of the base HVAC device block using the first electrical connection,
generate actuator control signals for operating the actuator of the base HVAC device block, and
transmit actuator control signals to the actuator of the base HVAC device block using the second electrical connection.

15: A computer program product comprising computer-readable instructions, which, when carried out by an add-on electronic circuit of an add-on HVAC device block according to claim 1, cause the add-on HVAC device block to operate:
in a sensor operation mode with a base HVAC device block having an HVAC functional device comprising a sensor configured to measure a parameter of an HVAC system; and
in an actuator operation mode with a base HVAC device block having an HVAC functional device comprising an actuator for actuating a mechanically attached actuated part.

16: The computer program product according to claim 15, wherein the computer-readable instructions, when carried out by the add-on electronic circuit, cause the add-on HVAC device block to:
activate the sensor operation mode, upon attachment to a base HVAC device block having an HVAC functional device comprising a sensor configured to measure a parameter of an HVAC system; and
activate the actuator operation mode upon attachment to a base HVAC device block having an HVAC functional device comprising an actuator for actuating a mechanically attached actuated part.

17: The computer program product according to claim 15, wherein the computer-readable instructions, when carried out by the add-on electronic circuit, further cause the add-on HVAC device block to load the sensor command set and/or the actuator command set in accordance with the sensor operation mode respectively the actuator operation mode from a memory device comprised by or communicatively connectable to the add-on HVAC device block.

18: The add-on HVAC device block according to claim 8, wherein the synchronous serial communication interface comprises as an I₂C, an SPI. UART and/or a TWI interface

19: The add-on HVAC device block according to claim 11, wherein the communication interface comprises a wired communication interface or a wireless communication interface.
